(19) United States
(12) Patent Application Publication
(10) Pub. No.: US 2023/0371723 A1
(43) Pub. Date: Nov. 23, 2023

(54) Outdoor Furniture Cover with Charging Facilities

(71) Applicant: Lamplight Farms Incorporated, Menomonee Falls, WI (US)

(72) Inventors: KYLE RESSLER, West Bend, WI (US); Ben Yu, New Berlin, WI (US); Andrew Alan Harmeling, Milwaukee, WI (US)

(21) Appl. No.: 18/198,075

(22) Filed: May 16, 2023

Related U.S. Application Data
(60) Provisional application No. 63/343,350, filed on May 18, 2022.

(51) Int. Cl. A47G 11/00; H02S 30/20

(52) U.S. Cl. CPC A47G 11/004; H02S 30/20

(57) ABSTRACT

A solar powered cover for outdoor furniture having enhanced functions. The outdoor furniture defines a table top supported by a base that defines an interior for receiving a fuel tank. A solar cover is received on the table top for covering the outdoor furniture. A solar panel is affixed to the top portion of the cover and communicates with the solar panel. The enhanced functions may include lighting, an insect repellent dispenser, and a battery adapted to receive power from the solar panel. The battery may facilitate activation of lights, an insect repellent dispenser, controls or indicators. Controls for activating a controller may be provided for controlling the enhanced functions. The controller may be adapted to receive power from the solar panel, a battery, or a cord connected to a plug-in outlet. The cover may include a securing device for securing the solar cover on the outdoor furniture.

### CROSS-REFERENCE TO RELATED CASES

This application claims the benefit of U.S. provisional patent application Ser. No. 63/343,350, filed on May 18, 2022, and incorporates such provisional application by reference into this disclosure as if fully set out at this point.

### FIELD OF THE INVENTION

The invention relates generally to outdoor furniture. More particularly, the invention relates to a solar cover for providing power to outdoor furniture having enhanced functionality such as insect repellent dispersal and accent lighting.

### BACKGROUND OF THE INVENTION

Outdoor fire pits are popular recreational items allowing consumers to enjoy the appearance and ambiance of a fire on demand. Gas fire pits allow for near instantaneous starting of the fire and the fire may be extinguished on demand. Opportunities also exist for integration of gas fire pit devices into tables and other furniture.

Firepits may employ the use of features that require power. However, utilizing a power cord to provide power to a firepit may not be feasible in some outdoor environments.

What is needed is a system and method for addressing the above, and related, issues.

### SUMMARY OF THE INVENTION

A solar powered cover and a combination of a solar powered cover and outdoor furniture having enhanced functions is provided. The outdoor furniture may be a modular table unit that defines a table top supported by a base that defines an interior for receiving a fuel tank.

A solar cover is received on the table top for covering the outdoor furniture to provide protection from the environment. The solar cover has a top portion defining a perimeter and a side portion affixed to the perimeter of the top portion. The side portion has a bottom edge. A solar panel is affixed to the top portion of the cover. The solar panel may be flexible or rigid.

The outdoor furniture may be provided with enhanced features, such as lighting, an insect repellent dispenser for dispensing a repellent in proximity to the outdoor furniture, power storage via a battery adapted to receive power from the solar panel, or other functions. The battery may deliver power to facilitate activation of the lights, the insect repellent dispenser, and controls or indicators. The outdoor furniture may include a controller for controlling the enhanced functions, and user controls for activating the controller. The controller communicates with at least one of lighting, a repellent dispenser, a fuel controller, and a power receptacle. The controller may be adapted to receive power via the power receptacle from the cord in communication with the solar panel, a battery, and a cord connected to a plug-in outlet.

The top portion of the solar cover may define a power cord opening for receiving the cord, and may include a securing device adjacent to the bottom edge of the side portion of the solar cover for securing the solar cover on the outdoor furniture. The securing device may be elastic or a drawstring for securing the solar powered cover to the outdoor furniture.

In one embodiment, the furniture is a modular table unit that can be mounted and secured to a propane fire table.

In one embodiment, the modular table unit can harvest electricity via solar panel. In another embodiment, the modular table unit can run on battery power that may be charged via the solar panel or via a plug-in outlet. In another embodiment, the modular table unit may be plugged into a conventional outlet for operation.

In a preferred embodiment, the modular table unit can harvest electricity via solar panels such that a connected battery pack will charge with 8 hours in full sun within 2-3 days.

Preferably, the modular table unit can store sufficient electricity to activate a repellent dispenser to dispense pest repellent and illuminate accent lighting for up to 12-16 hours.

In one embodiment, the modular table unit can mount two repellent pods that contain a repellent, e.g., Lamplight Farm repellent pods. In one embodiment, repellent pods require heating to 128° C. for proper dispersion.

The modular table unit preferably is provided with an LED functional indicator.

The modular table unit preferably is provided with accent lighting, e.g., 6×1 W RGB+Amber LEDs.

The modular table unit of the invention is preferably weather-proof for all sub-assemblies and final assembly.

A modular table unit of the invention may be sold with a stainless steel tabletop with built in door or drawer, a 2 pack of BiteFighter repellent pods, a battery bank, mounting hardware, a solar charging cover, and an instruction manual.

### BRIEF DESCRIPTION OF THE DRAWINGS

FIG. 1 is a perspective view of table top being located onto a base to form outdoor furniture;

FIG. 2 is a perspective view of a table top and a base to form outdoor furniture wherein a bottom surface of the table top is visible;

FIG. 3 is a perspective view of an assembled table top and base forming outdoor furniture;

FIG. 4 is an enlarged perspective view of a base of FIGS. 1-3;

FIG. 5 is an enlarged perspective of a table top of FIGS. 1-3;

FIG. 6 is a perspective view of a fuel tank;

FIG. 7 is a perspective view of a printed circuit board;

FIG. 8 is a perspective view of a light harness with a plurality of lights;

FIG. 9 is a perspective view of the table top of FIG. 5 having a drawer sized to receive a portable charger therein;

FIG. 10 is an elevation view of the table top of FIGS. 1-3 and 5 showing a perimeter with a power receptacle, controls and an indicator;

FIG. 11 is a perspective view of the table top of FIGS. 1-3 and 5 showing a power cord being received in a power receptacle;

FIG. 12 is a perspective view of a repellent container for containing an insect repellent;

FIG. 13 is a perspective view of the repellent container of FIG. 12 being installed in a container receptacle on a bottom surface of the table top of FIG. 5;

FIG. 14 is an enlarged perspective view of the repellent container and container receptacle of FIG. 13;

FIG. 15 is a perspective view of outdoor furniture showing repellent containers installed within the container receptacles of FIG. 13;

FIG. 16 is a perspective view of a solar powered cover installed over the table top of FIGS. 1-3 and 5.

FIG. 17 is a perspective view of the solar powered cover of FIG. 16 being installed on the outdoor furniture of FIGS. 1-3;

FIG. 18 is a perspective view of the solar powered cover of FIG. 16 installed on the outdoor furniture of FIGS. 1-3.

FIG. 19 is an electrical schematic showing interconnectedness of various components with the power receptacle of FIG. 11.

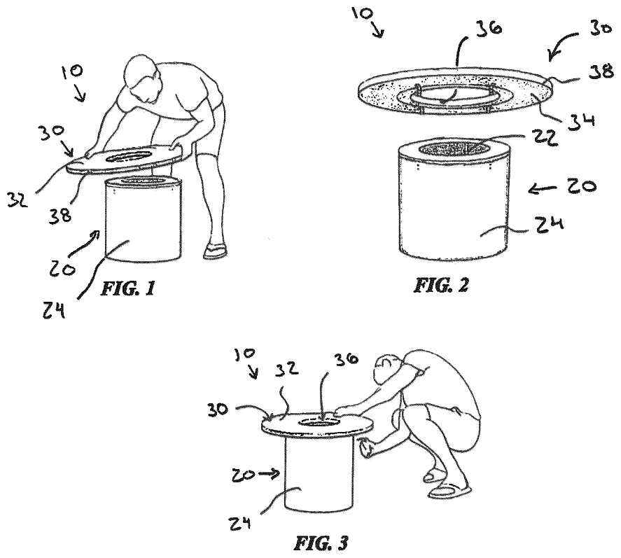

### DETAILED DESCRIPTION OF THE PREFERRED EMBODIMENTS

Outdoor furniture is designated generally 10. Outdoor furniture 10 may be a modular table unit. Outdoor furniture includes a base 20 that defines interior 22, outer surface 24, and upper surface 26.

Tabletop 30 is received on upper surface 26 of base 20. Tabletop 30 defines a top surface 32 and a bottom surface 34. Top surface 32 and bottom surface 34 define fire opening 36. Tabletop 30 defines perimeter surface 38. Perimeter surface 38 defines drawer opening 40. Drawer 42 is slidably received within drawer opening 40.

Controls are located on perimeter surface 38. Controls may include a plurality of buttons 52. Plurality of buttons 52 may include repellent button 54 and illumination button 56. Indicators 58 may also be provided on perimeter surface 38.

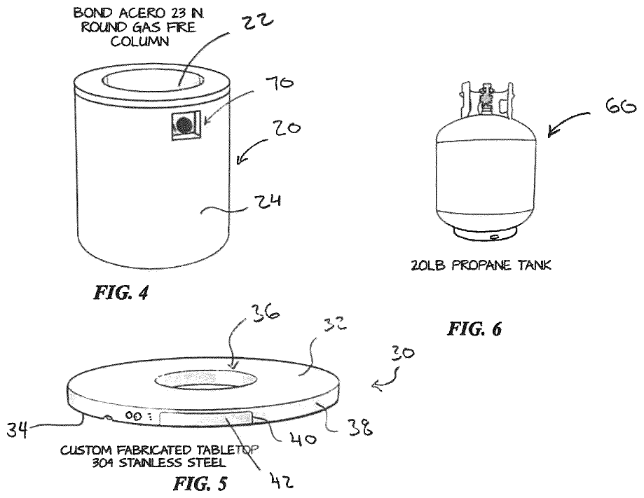

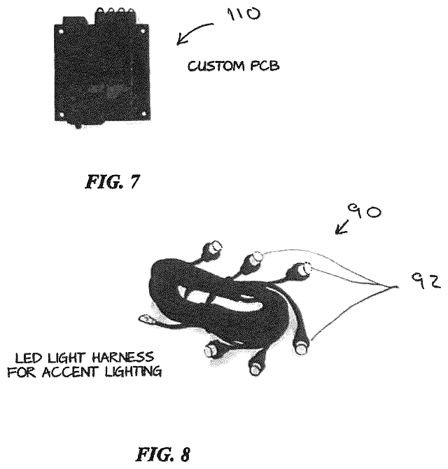

Fuel tank 60 (FIG. 6) may be received within interior 22 of base 20. Fuel controller 70 (FIG. 4) is accessible on outer surface 24 of base 20. Fuel controller 70 is for controlling a release of fuel from fuel tank 60 to a burner below fire opening 36.

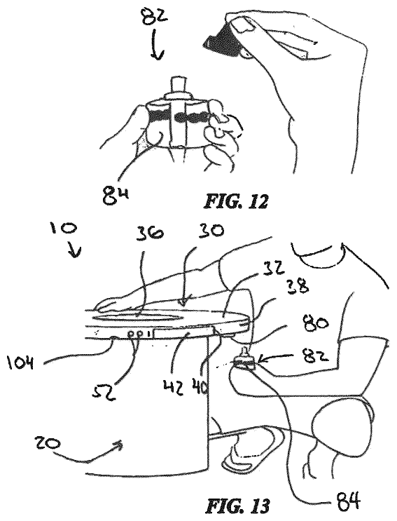

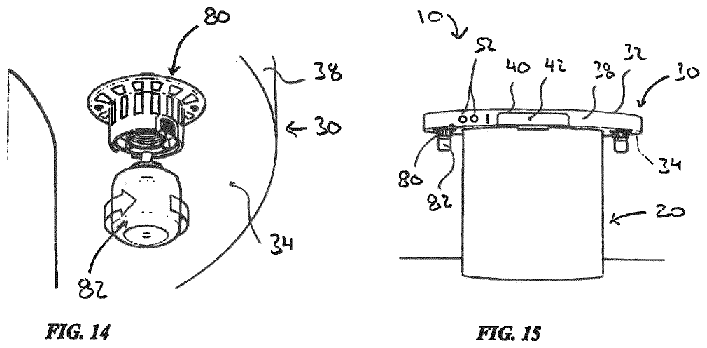

Container receptacle 80 (FIGS. 13-15) is provided on bottom surface 34 of tabletop 30. Repellent container 82 contains a repellent substance 84. Repellent container 82 is received by container receptacle 80. In one embodiment container receptacle 80 includes a heating element for selective heating of repellent container 80 for activating and dispersing repellent in the proximity of outdoor furniture 10.

Lighting harness 90 (FIG. 8) has a plurality of lights 92. Plurality of lights 92 are preferably located adjacent to bottom surface 34 of tabletop 30.

The power source is designated generally 100. Power receptacle 104 is provided adjacent to perimeter surface 38 of tabletop 30.

A controller, such as a printed circuit board (PCB), is designated generally 110 (FIG. 7). Controller 110 is in operative communication with controls, such as buttons 52, indicator 58, fuel controller 70, lighting harness 90, container receptacle 80, and power source 100.

In one embodiment, power source 100 is one of portable charger 102 or a power source connected to power receptacle 104.

Electrical cables 120 (FIG. 8) extend from controller 110 into drawer 42. In one embodiment, portable charger 102 is sized to be received within drawer 42 and adapted to connect to electrical cable 120 to provide power to controller 110. In one embodiment, when repellent button 54 is depressed, repellent substance 84 is distributed around tabletop 30 to form a repellent zone.

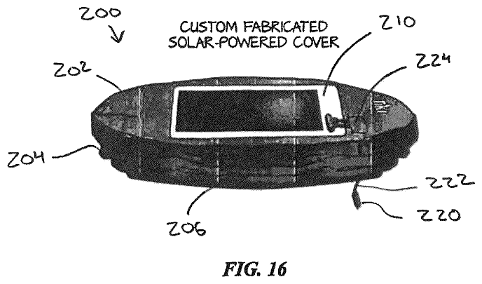

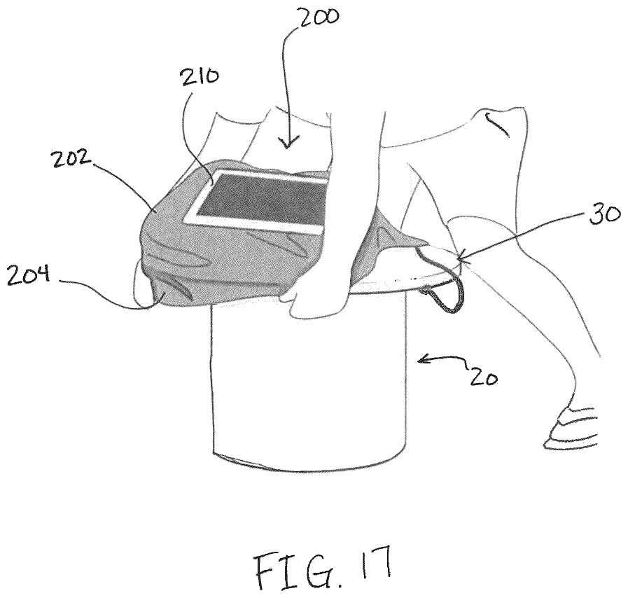

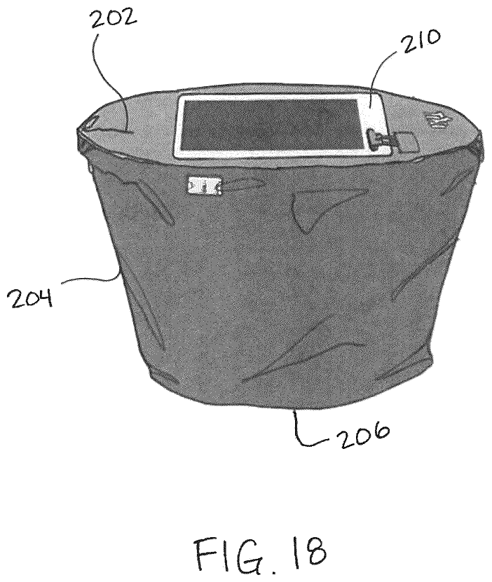

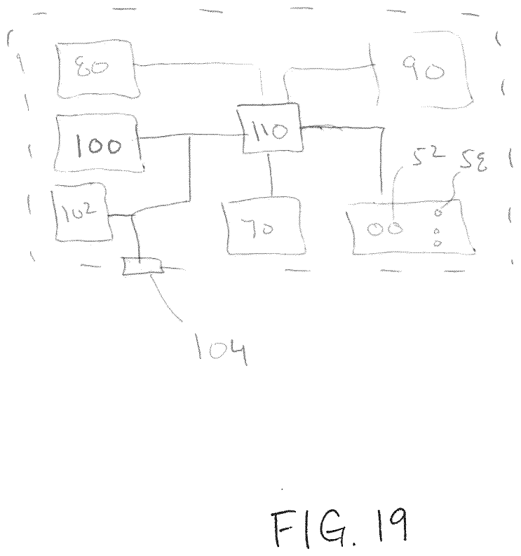

Referring now to FIGS. 16-18, shown is solar powered cover 200. Solar powered cover is preferably constructed of a flexible material, such as canvas, nylon or other material that is weather resistant. Solar powered cover 200 has top portion 202 and side portion 204. A bottom edge of side portion 204 may be provided with securing device 206, such as elastic or a drawstring for securing solar powered cover 200 to outdoor furniture 10.

Solar powered cover 200 includes solar panel 210. In one embodiment, solar panel 210 is flexible. However, solar panel 210 may also be rigid. Solar panel 210 is preferably affixed to top portion 202 of solar powered cover 200 with an adhesive, fasteners, sewn thereto, otherwise affixed to top portion 202.

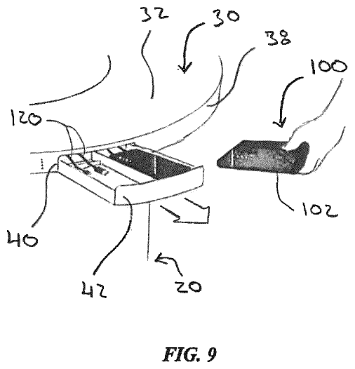

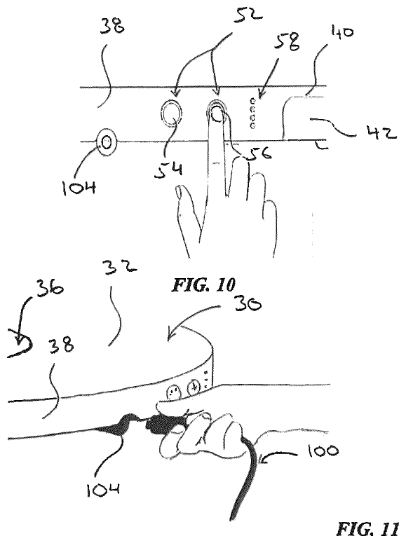

Electrical connector 220 (FIG. 16) is provided for engaging power receptacle 104 (FIG. 11). Electrical connector 220 is affixed to cover cord 222. Cover cord 222 passes through power cord opening 224 formed in top portion 202 of solar powered cover 200 for engaging solar panel 210. Cover cord 222 and electrical connector 220 transfer electrical power from solar panel 210 to batteries, such as an permanently installed battery or portable chargers 102 (FIG. 9) via electrical cables 120 (FIG. 11).

Referring now to FIGS. 17 and 18, solar powered cover 200 may be installed by slipping cover 200 over table top 30 of outdoor furniture 10 such that top portion 202 of cover 200 covers table top 30. Side portion 204 is pulled downwardly toward the ground where securing device 206 secures a bottom edge of cover 200.

In one embodiment, outdoor furniture 10, or modular table unit, can harvest electricity via solar panel 210. In another embodiment, the modular table unit 10 can run on battery power that may be charged via solar panel 210 or via a plug-in outlet inserted into power receptacle 104. In another embodiment, the modular table unit 10 may be plugged into a conventional outlet via power receptacle 104 for operation.

In a preferred embodiment, outdoor furniture 10 can harvest electricity via solar panel 210 such that a connected battery pack or portable charger 102, e.g., via cover cord 222, will charge with 8 hours in full sun within 2-3 days.

Preferably, outdoor furniture 10 can store sufficient electricity to perform enhanced functions such as powering container receptacle 80 for dispensing pest repellent and illuminating accent lights 92 for up to 12-16 hours, and powering an LED functional indicator 58.

In one embodiment, accent lights 92 are 6×1 W RGB+Amber LEDs.

Outdoor furniture 10 of the invention is preferably weather-proof for all sub-assemblies and final assembly. In one embodiment, table top 30 of outdoor furniture 10 is stainless steel. Drawer 42 of table top 30 is preferably sized to contain a 2 pack of repellent containers 82, such as BiteFighter™ repellent pods, portable charger 102, mounting hardware, solar charging cover 200, and an instruction manual.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A solar powered cover for outdoor furniture comprising:
a top portion defining a perimeter;
a side portion affixed to said perimeter of said top portion, said side portion having a bottom edge;
a solar panel affixed to said top portion of the cover;
a cord having a connected end and a distal end, said connected end in communication with said solar panel, said cord having an electrical connector at said distal end.

2. The solar powered cover according to claim 1 wherein:
said top portion defines a power cord opening for receiving said cord.

3. The solar powered cover according to claim 1 further comprising;
a securing device adjacent said bottom edge of said side portion for securing the cover on the outdoor furniture.

4. The solar powered cover according to claim 3 wherein:
said securing device is elastic or a drawstring for securing the cover to the outdoor furniture.

5. The solar powered cover according to claim 1 wherein:
said solar panel is flexible.

6. The solar powered cover according to claim 1 wherein:
said solar panel is rigid.

7. A solar powered outdoor furniture and cover combination comprising:
outdoor furniture having enhanced functions, said outdoor furniture defining a table top;
a cover for covering said outdoor furniture, said cover having a top portion defining a perimeter, a side portion affixed to said perimeter of said top portion, said side portion having a bottom edge,
wherein a solar panel is affixed to said top portion of said cover;
a cord having a connected end and a distal end, said connected end in communication with said solar panel, said cord having an electrical connector at said distal end.

8. The combination of claim 7 wherein:
said outdoor furniture is a modular table unit wherein said top portion is supported by a base defining an interior for receiving a fuel tank.

9. The combination of claim 7 wherein:
said enhanced functions comprise lighting.

10. The combination of claim 7 wherein:
said enhanced functions comprise a repellent dispenser having a repellent receptacle for receiving a repellent container, said repellent dispenser for dispensing a repellent in proximity to said outdoor furniture.

11. The combination according to claim 7 wherein:
said enhanced functions include power storage via a battery adapted to receive power from said solar panel, said battery for providing power to facilitate activation of a light, an insect repellent dispenser, controls or indicators.

12. The combination according to claim 7 wherein:
said outdoor furniture includes a controller for controlling said enhanced functions.

13. The combination according to claim 12 further comprising:
user controls for activating said controller.

14. The combination according to claim 12 wherein:
said controller is in communication with at least one of lighting, a repellent dispenser, a fuel controller, and a power receptacle.

15. The combination according to claim 12 wherein:
said controller is adapted to receive power from said cord in communication with said solar panel, from a battery, and from a cord connected to a plug-in outlet.

16. The combination according to claim 7 wherein:
said top portion of said cover defines a power cord opening for receiving said cord.

17. The combination according to claim 7 further comprising;
a securing device adjacent said bottom edge of said side portion of said cover for securing said cover on said outdoor furniture.

18. The combination according to claim 17 wherein:
said securing device is elastic or a drawstring for securing the cover to said outdoor furniture.

19. The combination according to claim 7 wherein:
said solar panel is flexible.

20. The combination according to claim 7 wherein:
said solar panel is rigid.
